(19) United States
(12) Patent Application Publication
(10) Pub. No.: US 2016/0156387 A1
(43) Pub. Date: Jun. 2, 2016

(54) METHOD AND SYSTEM FOR WIRELESS POWER AND DATA TRANSMISSION

(71) Applicant: SONY CORPORATION, Tokyo (JP)

(72) Inventor: TAKAAKI OTA, SAN DIEGO, CA (US)

(21) Appl. No.: 14/557,589

(22) Filed: Dec. 2, 2014

(51) Int. Cl. H04B 5/00; H02J 5/00; H02J 7/02

(52) U.S. Cl. CPC H04B 5/0037; H02J 7/025; H02J 5/005

(57) ABSTRACT

Various aspects of a method and device for wireless power and data transmission are disclosed herein. The method is executed within a first electronic device. The first electronic device receives a power and data from a second electronic device, via a first communication channel. The first electronic device transmits the received power and data to a third electronic device, via a wireless second communication channel.

### FIELD

Various embodiments of the disclosure relate to wireless power and data transmission. More specifically, various embodiments of the disclosure relate to wireless power and data transmission to electronic devices independent of the hardware and/or software configuration of the electronic devices.

### BACKGROUND

Recent advancements in the field of digital technology have facilitated a diverse variety of digital devices, such as smartphones or tablets. Such digital devices may provide numerous features that depend upon extended power supplies. Further, at times, such digital devices may need to communicate data between each other for various purposes. The latest communication technologies have made it possible to provide such power supplies and data transmissions wirelessly.

In certain scenarios, such extended power supplies may compensate for digital devices by use of existing wireless charging technologies. In other scenarios, wireless data transmissions may be provided by wireless universal serial bus (USB) adaptors, which may simulate the USB interface of a host machine. However, the existing wireless charging and data transmission technologies may require a substantial alteration of the hardware and/or software architecture of such digital devices, which may be undesirable.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

A method and a system for wireless power and data transmission are provided substantially as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram that illustrates a network environment for wireless power and data transmission, in accordance with an embodiment of the disclosure.

FIG. 2 is a block diagram that illustrates various components of a first electronic device, in accordance with an embodiment of the disclosure.

FIG. 3 illustrates an exemplary scenario to implement the disclosed method and system for wireless power and data transmission, in accordance with an embodiment of the disclosure.

FIG. 4 is a flow chart that illustrates a method for wireless power and data transmission, in accordance with an embodiment of the disclosure.

### DETAILED DESCRIPTION

Various implementations may be found in a method and/or a system for wireless power and data transmission. The method may be implemented in a first electronic device. The first electronic device may receive a power and data from a second electronic device, via a first communication channel. The received power and data may be transmitted to a third electronic device, via a wireless second communication channel. In accordance with an embodiment, the transmission of the received power to the third electronic device via the wireless second communication channel may be based on one of an electromagnetic induction, a magnetic resonance, and/or a magnetodynamic coupling.

In accordance with an embodiment, a first battery apparatus installed within the first electronic device may be charged based on the power received from a second battery apparatus. The second battery apparatus may be installed within the second electronic device. In accordance with an embodiment, the third electronic device may be authenticated prior to the transmission of the received power and the data, via the wireless second communication channel. In accordance with an embodiment, the second electronic device may correspond to a host device and the first electronic device may correspond to a client device. In accordance with an embodiment, one or more client communication protocols may be replicated such that the third electronic device may correspond to another client device. In accordance with an embodiment, the received power and data may be repeated for the third electronic device. In accordance with an embodiment, a connection interface of the third electronic device may be switched from a first interface to a second interface when a third communication channel is deployed between the first electronic device and the third electronic device.

In accordance with an embodiment, the third communication channel may be an on-the-go (OTG) universal serial bus (USB) cable. In accordance with an embodiment, the first communication channel may comprise one of a USB cable, an Ethernet cable and/or a cable with a lightning connector. In accordance with an embodiment, the wireless second communication channel may comprise one of a wireless fidelity (Wi-Fi) network, a Bluetooth network, a radio frequency (RF) network, and/or a near field communication (NFC) network. In accordance with an embodiment, the transmission of the power via the wireless second communication channel may be based on one or more wireless standards that may include Qi™.

In accordance with an embodiment, the first electronic device may be one of an adaptor, a charger, a cradle, and/or a connector. In accordance with an embodiment, the second electronic device may be one of a personal computer (PC), a laptop, a smartphone, a tablet, a phablet, and/or a personal digital assistant (PDA). In accordance with an embodiment, the third electronic device may comprise one of a laptop, a smartphone, a tablet, a phablet, and/or a PDA.

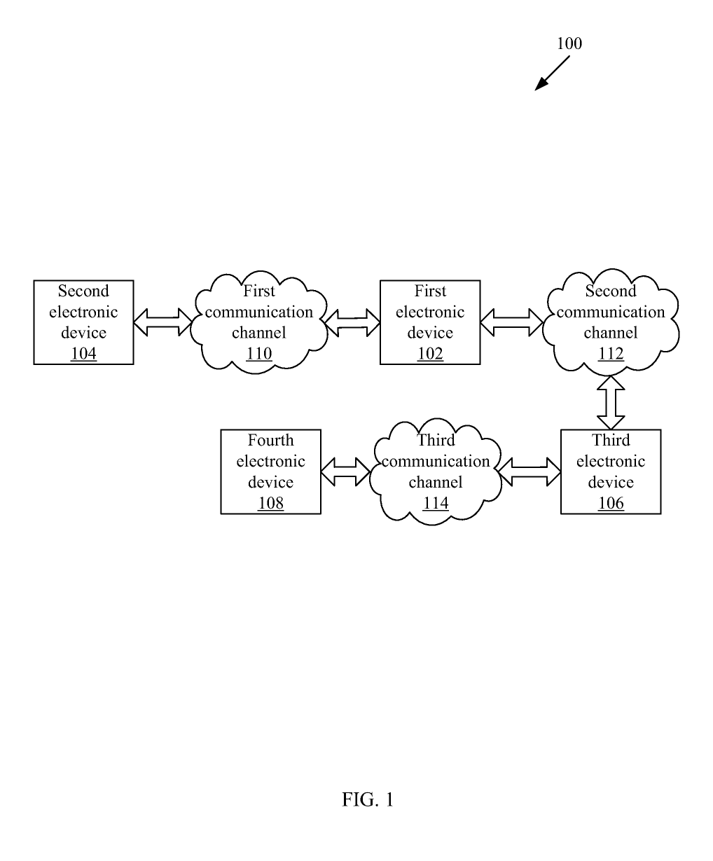

FIG. 1 is a block diagram that illustrates a network environment for wireless power and data transmission, in accordance with an embodiment of the disclosure. With reference to FIG. 1, a network environment 100 may comprise a first electronic device 102, a second electronic device 104, a third electronic device 106, a fourth electronic device 108, a first communication channel 110, a second communication channel 112, and a third communication channel 114. The first electronic device 102 may be communicatively coupled to the second electronic device 104, via the first communication channel 110. The first electronic device 102 may be communicatively coupled to the third electronic device 106, via the second communication channel 112. The third electronic device 106 may be further communicatively coupled to the fourth electronic device 108, via the third communication channel 114.

The first electronic device 102 may comprise suitable logic, circuitry, interfaces, and/or code that may be operable to receive power and data from the second electronic device 104, via the first communication channel 110. The first electronic device 102 may be operable to wirelessly transmit the received power and data to the third electronic device 106, via the second communication channel 112. The first electronic device 102 may be further operable to perform authentication of the third electronic device 106, prior to the transmission of the power and data. The first electronic device 102 may comprise a first battery apparatus. The first battery apparatus may be charged based on the power received from a second battery apparatus. The second battery apparatus may be installed within the second electronic device 104. In accordance with an embodiment, the first electronic device 102 may be a standalone device. In accordance with an embodiment, the first electronic device 102 may be integrated within the second electronic device 104. Examples of the first electronic device 102 may include, but are not limited to, an adaptor, a charger, a cradle, and/or a connector.

The second electronic device 104 may comprise suitable logic, circuitry, interfaces, and/or code that may be operable to communicate with the first electronic device 102. The second electronic device 104 may be a host device from which the power and data may be transmitted to the first electronic device 102, via the first communication channel 110. The second electronic device 104 may transmit the power from the second battery apparatus to the first battery apparatus, which is installed within the first electronic device 102. The second electronic device 104 may transmit the data retrieved from a local memory to the first electronic device 102. Examples of second electronic device 104 may include, but are not limited to, a laptop, a smartphone, a tablet, a phablet, and/or a PDA.

The third electronic device 106 may comprise suitable logic, circuitry, interfaces, and/or code that may be operable to communicate with the first electronic device 102. The third electronic device 106 may be operable to receive power and data wirelessly transmitted by the first electronic device 102, via the second communication channel 112. The third electronic device 106 may be further operable to communicate with the fourth electronic device 108, via the third communication channel 114. Examples of the third electronic device 106 may be similar to the examples of the second electronic device 104, as described above.

The fourth electronic device 108 may comprise suitable logic, circuitry, interfaces, and/or code that may be operable to communicate with the third electronic device 106. The fourth electronic device 108 may be operable to receive power and data transmitted by the third electronic device 106, via the third communication channel 114. In accordance with an embodiment, the data transmitted by the third electronic device 106 may include one or more commands, such as a print command. In accordance with an embodiment, the fourth electronic device 108 may correspond to a client device that may receive the power and data transmitted by the third electronic device 106. Examples of fourth electronic device 108 may include a USB printer, a USB code reader, a USB speaker, and/or the like.

The first communication channel 110 may include a wired medium that may enable communication between the first electronic device 102 and the second electronic device 104. Such communication may be performed in accordance with various wired communication protocols. Examples of such wired communication protocols may include, but are not limited to, Internet Protocol (IP), and/or universal serial bus (USB) transfer protocol. Examples of the first communication channel 110 may comprise a USB cable, an Ethernet cable, and/or a cable with lightning connector.

The second communication channel 112 may include a wireless medium that may enable communication between the first electronic device 102 and the third electronic device 106. Such communication may be performed in accordance with various wireless communication protocols. Examples of such wireless communication protocols may include, but are not limited to, Internet Protocol (IP), ZigBee, an enhanced data rates for global system for mobile communications (GSM) evolution (EDGE) protocol, an infrared (IR) protocol, IEEE 802.11, 802.16, cellular communication protocols, and/or Bluetooth (BT) communication protocols. The wireless communication protocols may further include one or more standards, such as Qi™. Examples of the second communication channel 112 may include, but are not limited to, a wireless medium (such as a wireless fidelity (Wi-Fi) network), a wireless local area network (WLAN), a Bluetooth network, a radio frequency (RF) network, an infrared (IR) network, and/or a near field communication (NFC) network.

The third communication channel 114 may include a wired medium that may enable another communication between the third electronic device 106 and fourth electronic device 108. Such communication may be performed in accordance with various wired communication protocols, as explained above. Examples of the third communication channel 114 may comprise, but not limited to, an on-the-go (OTG) universal serial bus (USB) cable.

In operation, the first electronic device 102 may receive a request for power and data transmission from the third electronic device 106, via the second communication channel 112. Examples of the data may include, but are not limited to, audio files, video files, image files, and/or text documents. In response to the received request, the first electronic device 102 may authenticate the third electronic device 106, prior to the transmission of power and data. In accordance with an embodiment, the authentication may be performed based on various state of the art authentication algorithms, such as a hash-based message authentication code (HMAC-MD5), a data encryption standard (DES), and an advanced encryption standard (AES). In accordance with an embodiment, the authentication may be performed based on a short range inductive communication technology, such as the NFC technology. In accordance with an embodiment the NFC technology may be utilized to “wake up” the first electronic device 102 when the third electronic device 106 is detected based on an event within a pre-determined proximity. In accordance with an embodiment, the event may be a tapping operation between the first electronic device 102 and the third electronic device 106. In accordance with an embodiment, the NFC technology may provide the authentication mechanism to enhance safety and reduce standby energy consumption.

In accordance with an embodiment, the authentication may be unsuccessful. In such a case, the first electronic device 102 may deny the identification of the third electronic device 106. The first electronic device 102 may generate an error notification for such a denial. The error notification may be output via a visual output (such as a display message), an audio output, and/or a haptic feedback.

In accordance with an embodiment, the authentication may be successful. In such a case, the first electronic device 102 may identify the third electronic device 106. In accordance with an embodiment, the first electronic device 102 may be operable to receive power from the second electronic device 104, via the first communication channel 110. In such a case, the power may be provided by the second battery apparatus installed within the second electronic device 104. In accordance with an embodiment, the first electronic device 102 may be operable to receive data from the second electronic device 104, via the first communication channel 110. In such a case, the power may be available within the first battery apparatus, which is installed within the first electronic device 102. In accordance with an embodiment, the first electronic device 102 may be operable to receive both the power and the data from the second electronic device 104, via the first communication channel 110.

The first electronic device 102 may transmit the power and the data to the third electronic device 106, via the second communication channel 112. In accordance with an embodiment, the power may be transmitted to the third electronic device 106 based on one or more wireless standards, such as Qi™. In accordance with an embodiment, the data may be transmitted to the third electronic device 106 based on one or more conventional data transfer protocols (such as Internet Protocol (IP)), via the second communication channel 112.

In accordance with an embodiment, the first electronic device 102 may be communicatively coupled to the second electronic device 104, via the first communication channel 110. In such a case, the second electronic device 104 may correspond to a host device and the first electronic device 102 may correspond to a client device. In accordance with an embodiment, the first electronic device 102 may be communicatively coupled to the third electronic device 106, via the second communication channel 112. In such a case, the first electronic device 102 may replicate one or more client communication protocols such that the third electronic device 106 may correspond to another client device. In accordance with an embodiment, the third electronic device 106 may be communicatively coupled to the fourth electronic device 108, via the third communication channel 114. In such a case, a connection interface of the third electronic device 106 may switch from a client-side interface to a host-side interface. Thus, the third electronic device 106 may correspond to a host device, and the other electronic device may correspond to a client device.

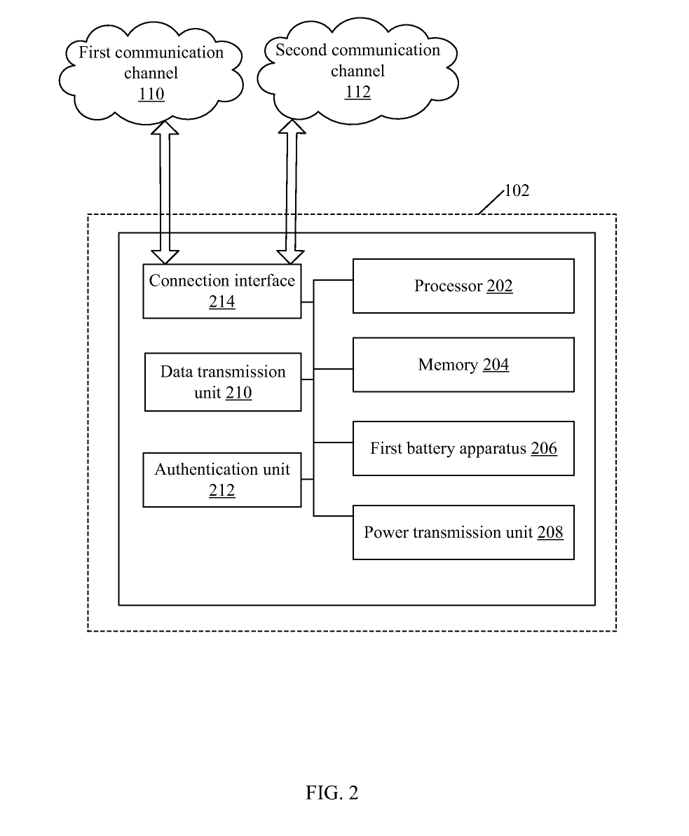

FIG. 2 is a block diagram that illustrates various components of the first electronic device 102, in accordance with an embodiment of the disclosure. FIG. 2 is explained in conjunction with elements from FIG. 1. With reference to FIG. 2, there is shown the first electronic device 102. The first electronic device 102 may comprise one or more processors, such as a processor 202, a memory 204, a first battery apparatus 206, a power transmission unit 208, a data transmission unit 210, an authentication unit 212, and a connection interface 214. The processor 202 may be communicatively connected to the memory 204, the first battery apparatus 206, the power transmission unit 208, the data transmission unit 210, the authentication unit 212, and the connection interface 214.

The processor 202 may comprise suitable logic, circuitry, interfaces, and/or code that may be operable to execute a set of instructions stored in the memory 204. The processor 202 may be implemented based on a number of processor technologies known in the art. The processor 202 may be operable to control the power transmission unit 208 and the data transmission unit 210. Examples of the processor 202 may be an X86-based processor, a reduced instruction set computing (RISC) processor, an application-specific integrated circuit (ASIC) processor, a complex instruction set computing (CISC) processor, and/or other such processor.

The memory 204 may comprise suitable logic, circuitry, interfaces, and/or code that may be operable to store the set of instructions, which may be executed by the processor 202. The memory 204 may be further operable to store one or more authentication algorithms, which may be known in the art. The memory 204 may be further operable to store the data received from the second electronic device 104. The memory 204 may be implemented based on a random access memory (RAM), a read-only memory (ROM), a hard disk drive (HDD), a storage server, and/or a secure digital (SD) card.

The first battery apparatus 206 may comprise suitable logic, circuitry, and interfaces that may be operable to provide electrochemical energy to the power transmission unit 208, whenever required. The first battery apparatus 206 may be a rechargeable battery that may comprise one or more electrochemical cells. In accordance with an embodiment, the first battery apparatus 206 may be charged by a direct power, via a suitable adaptor. In accordance with another embodiment, the first battery apparatus 206 may be a charged by the second battery apparatus installed within the second electronic device 104, via the first communication channel 110. The first battery apparatus 206 may further comprise a power accumulator used for electrochemical energy storage. Examples of different combinations of chemicals that may be used in the first battery apparatus 206, may include, but are not limited to, lead-acid, nickel cadmium (NiCd), nickel metal hydride (NiMH), lithium ion (Li-ion), and/or lithium ion polymer (Li-ion polymer).

The power transmission unit 208 may comprise suitable logic, circuitry, interfaces, and/or code that may be operable to transmit the power to the third electronic device 106, via the second communication channel 112. In accordance with an embodiment, the power may be received from the second electronic device 104, via the first communication channel 110. In accordance with another embodiment, the power may be received from the first battery apparatus 206. The power transmission unit 208 may transmit the received power based on one or more wireless standards, such as Qi™. The power transmission unit 208 may transmit the received power to the third electronic device 106, based on a software configuration of the connection interface 214. The power transmission unit 208 may be based on technologies, such as electromagnetic induction, magnetic resonance, magnetodynamic coupling, and/or the like.

The data transmission unit 210 may comprise suitable logic, circuitry, interfaces, and/or code that may be operable to transmit data to the third electronic device 106, via the second communication channel 112. The data transmission unit 210 may receive the data from a second electronic device 104, via the first communication channel 110. The data transmission unit 210 may transmit the data to the third electronic device 106 based on the software configuration of the connection interface 214.

The authentication unit 212 may comprise suitable logic, circuitry, interfaces, and/or code that may be operable to authenticate the third electronic device 106 prior to transmission of the power and the data to the third electronic device 106. The authentication unit 212 may be implemented in conjugation with the processor 202 and the memory 204. The authentication unit 212 may utilize the one or more authentication algorithms to authenticate the third electronic device 106. The one or more authentication algorithms may be retrieved from the memory 204. In accordance with an embodiment, the NFC technology may be implemented by the authentication unit 212 to authenticate the third electronic device 106.

The connection interface 214 may comprise suitable logic, circuitry, interfaces, and/or code that may be operable to receive the power and the data from external devices, such as the second electronic device 104, via the first communication channel 110. The connection interface 214 may be operable to transmit the received power and the data to the third electronic device 106. In accordance with an embodiment, the connection interface 214 may act as a repeater to transmit the power and the data to the third electronic device 106. In accordance with an embodiment, the connection interface 214 may be configured in such a manner that the first electronic device 102 may correspond to a client device for the second electronic device 104, when connected via the first communication channel 110. In accordance with an embodiment, the connection interface 214 may be configured in such a manner that the first electronic device 102 may correspond to a client device for the third electronic device 106, when connected via the second communication channel 112. Examples of the connection interface 214 may include a USB interface, a micro USB interface, an Ethernet controller interface, and/or a lightning connector interface.

In operation, the processor 202 may receive a request for power and data transmission from the third electronic device 106, via the wireless second communication channel 112. In response to the request, the authentication unit 212 may authenticate the third electronic device 106 prior to transmission of the power and data. In accordance with an embodiment, the authentication may be performed based on a short-range inductive communication technology, such as the NFC technology.

In accordance with an embodiment, the authentication may be unsuccessful. In such a case, the processor 202, in conjunction with the authentication unit 212, may deny the identification of the third electronic device 106. The processor 202 may generate an error notification for such a denial. The error notification may be communicated via a visual output (such as a display message, “Invalid Device”), an audio output, and/or a haptic feedback (such as a predetermined number and predetermined direction of vibrations).

In accordance with an embodiment, the authentication may be successful. In such a case, the processor 202, in conjunction with the authentication unit 212, may identify the third electronic device 106. In accordance with an embodiment, the processor 202 may be operable to receive the power from the second electronic device 104, via the first communication channel 110. In such a case, the power may be received from the second battery apparatus installed within the second electronic device 104. In accordance with an embodiment, the processor 202 may be operable to receive the data from the second electronic device 104, via the first communication channel 110. In such a case, the power may be available within the first battery apparatus 206 installed within the first electronic device 102. In accordance with an embodiment, the first electronic device 102 may be operable to receive both the power and the data from the second electronic device 104, via the first communication channel 110.

In accordance with an embodiment, the processor 202 may be operable to receive the power from the second electronic device 104 based on one or more wireless standards, such as Qi™. In accordance with an embodiment, the processor 202 may receive the data from the second electronic device 104, via the connection interface 214. Examples of the connection interface 214 may comprise a Type “B” micro USB connection interface, which is known in the art.

In accordance with an embodiment, the processor 202 may be configured to replicate one or more client communication protocols at the first electronic device 102. Based on the replication of the one or more client communication protocols, the connection interface 214 may facilitate the first electronic device 102 to appear as the client device to the other client device, such as the third electronic device 106. Based on the replication of the one or more client communication protocols, the third electronic device 106 may correspond to another client device. In accordance with an embodiment, the connection interface 214 may enable the transmission of the power and the data to the third electronic device 106, via the second communication channel 112. In accordance with an embodiment, the processor 202, in conjunction with the power transmission unit 208 and data transmission unit 210, may transmit the power and the data to the third electronic device 106, via the wireless second communication channel 112. As explained above, the power may be transmitted based on one or more wireless standards, such as Qi™. Further, the data transmission may be performed based on a wireless data interface, via a Wi-Fi and/or Bluetooth network.

In accordance with an embodiment, a connection interface of the third electronic device 106 may switch from the client interface to a host interface when the third communication channel 114, such as the OTG cable, is deployed. The third communication channel 114 may be deployed between the third electronic device 106 and the fourth electronic device 108. For example, the third electronic device 106, such as a smartphone, may act as a host device and may send a print command to the other electronic device, such as a USB printer, which may act as a client device.

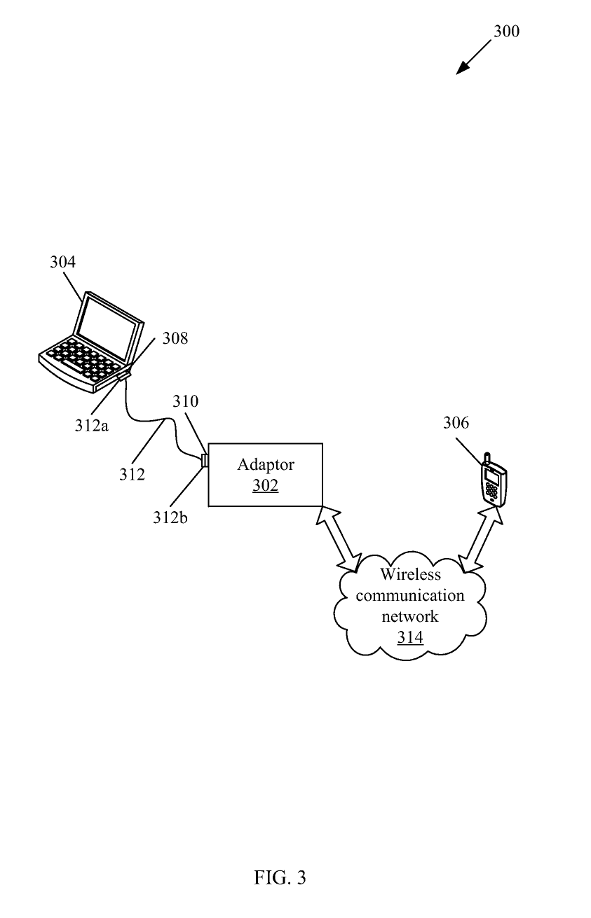

FIG. 3 illustrates an exemplary scenario 300 to implement the disclosed device and method for wireless power and data transmission, in accordance with an embodiment of the disclosure. FIG. 3 is explained in conjunction with elements from FIG. 1 and FIG. 2. With reference to FIG. 3, there is shown a personal computer 304, an adaptor 302, and a smartphone 306. There is further shown a Type “A” USB connection interface 308, a Type “B” micro USB connection interface 310, a standard USB cable 312, and a wireless communication network 314. The standard USB cable 312 may comprise a Type “A” USB plug 312a and a Type “B” micro USB plug 312b.

The personal computer 304 and the adaptor 302 may comprise the Type “A” USB connection interface 308 and the Type “B” micro USB connection interface 310, respectively. The personal computer 304 and the adaptor 302 may be communicatively coupled via the standard USB cable 312. The adaptor 302 and the smartphone 306 may be communicatively coupled via the wireless communication network 314 and the smartphone 306. The standard USB cable 312 may comprise the Type “A” USB plug 312a that may be connected with the Type “A” USB connection interface 308. The standard USB cable 312 may comprise the Type “B” micro USB plug 312b that may be connected with the Type “B” micro USB connection interface 310.

The personal computer 304, the adaptor 302, and the smartphone 306, may be similar to the first electronic device 102 (FIG. 1), the second electronic device 104 (FIG. 1), and the third electronic device 106 (FIG. 1), respectively. The standard USB cable 312 and the wireless communication network 314 may be similar to the first communication channel 110 (FIG. 1) and the second communication channel 112 (FIG. 1), respectively.

With reference to the exemplary scenario 300, the adaptor 302 may authenticate the smartphone 306 when a tapping operation is performed between the adaptor 302 and the smartphone 306. In accordance with an embodiment, the adaptor 302 may authenticate the smartphone 306 based on the NFC protocols. In accordance with an embodiment, the adaptor 302 may authenticate the smartphone 306 based on an exchange a set of private and/or public keys.

Once the adaptor 302 identifies the smartphone 306 as an authenticated electronic device, the adaptor 302 may be operable to transmit the power and required data to the smartphone 306. The Type “A” USB plug 312a may be inserted into the Type “A” USB connection interface 308 of the personal computer 304, and the Type “B” micro USB plug 312b may 308 be inserted into the Type “B” micro USB connection interface 310 of the adaptor 302. The Type “B” micro USB connection interface 310 may be configured in such a manner that the adaptor 302 may replicate one or more client communication protocols, such that the smartphone 306 may correspond to another client device. The adaptor 302 may receive the power and the data from the personal computer 304, via the standard USB cable 312 connected between the personal computer 304 and the adaptor 302. In accordance with an embodiment, the adaptor 302 may be utilized as a repeater to provide the power and the data to the smartphone 306.

In accordance with an embodiment, the adaptor 302 may transmit the received power and the data to the smartphone 306, via the wireless communication network 314. In accordance with an embodiment, the power may be transmitted to the smartphone 306 based on one or more wireless standards, such as Qi™. Further, the data may be transmitted based on a wireless data interface, via the Wi-Fi and/or Bluetooth network.

In accordance with an embodiment, the smartphone 306 may be connected to the fourth electronic device 108, such as a USB printer, via the on-the-go (OTG) universal serial bus (USB) cable. In such a case, the smartphone 306 may act as a host for the USB printer, to transmit print commands to the USB printer.

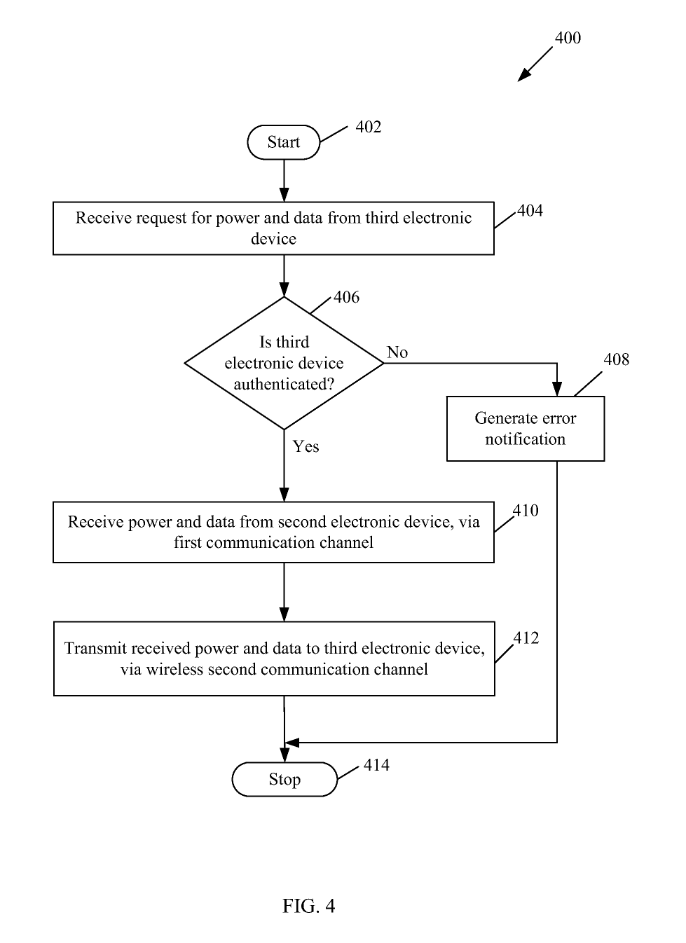

FIG. 4 is a flow chart that illustrates a method 400 for wireless power and data transmission, in accordance with an embodiment of the disclosure. FIG. 4 is described in conjunction with elements of FIG. 1 and FIG. 2. With reference to FIG. 4, the method 400 may be implemented in the first electronic device 102. The first electronic device 102 may be communicatively coupled to the second electronic device 104, via the first communication channel 110. The first electronic device 102 may be communicatively coupled to the third electronic device 106, via the wireless second communication channel 112.

The method 400 begins at step 402 and proceeds to step 404. At step 404, a request for the power and the data may be received from the third electronic device 106. At step 406, it may be determined that the third electronic device 106 is authenticated. In an instance where the third electronic device 106 is not authenticated, the method proceeds to step 408. At step 408, an error notification may be generated, and the control proceeds to end step 414. In an instance where the third electronic device 106 is authenticated, the method proceeds to step 412. At step 412, the power and the data may be received from the second electronic device 104, via the first communication channel 110. At step 414, the power and the data may be transmitted to the third electronic device 106, via the second communication channel 112. Control passes to end step 416.

In accordance with an embodiment of the disclosure, a system for wireless transmission of power and data is disclosed. The system may comprise one or more processors, such as the processor 202 (FIG. 2), in a first electronic device 102 (FIG. 1). The first electronic device 102 may be communicatively coupled to the second electronic device 104 (FIG. 1), via the first communication channel 110 (FIG. 1). The first electronic device 102 may be communicatively coupled to the third electronic device 106 (FIG. 1), via the wireless second communication channel 112 (FIG. 1). The processor 202 may be operable to receive power and data from the second electronic device 104, via the first communication channel 110. The processor 202 may be further operable to transmit the received power and data to the third electronic device 106 (FIG. 1), via the wireless second communication channel 112.

Various embodiments of the disclosure may provide a non-transitory computer readable medium and/or storage medium, and/or a non-transitory machine readable medium and/or storage medium having stored thereon, a machine code and/or a computer program with at least one code section executable by a machine and/or a computer for wireless power and data transmission. The at least one code section in a first electronic device 102 may cause the machine and/or computer to perform the steps, which may comprise receipt of the power and the data from a second electronic device 104, via a first communication channel 110. The received power and data may be transmitted to the third electronic device 106, via a wireless second communication channel 112.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted to carry out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

The present disclosure may also be embedded in a computer program product, which comprises all the features enabling the implementation of the methods described herein, and which when loaded in a computer system is able to carry out these methods. In the present context, computer program means any expression, in any language, code or notation, of a set of instructions intended to cause a system having an information processing capability to perform a particular function either directly, or after either or both of the following: a) conversion to another language, code or notation; b) reproduction in a different material form.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What is claimed is:

1. A method for wireless power and data transmission, said method comprising:
in a first electronic device:
receiving power and data from a second electronic device via a first communication channel; and
transmitting said received said power and said data to a third electronic device via a wireless second communication channel.

2. The method of claim 1, wherein said transmission of said received power to said third electronic device via said wireless second communication channel is based on one of: an electromagnetic induction, a magnetic resonance, and/or a magnetodynamic coupling.

3. The method of claim 1, further comprising charging a first battery apparatus installed within said first electronic device based on said power received from a second battery apparatus installed within said second electronic device.

4. The method of claim 1, further comprising authenticating said third electronic device prior to said transmission of said received said power and said data via said wireless second communication channel.

5. The method of claim 1, wherein said second electronic device corresponds to a host device and said first electronic device corresponds to a client device.

6. The method of claim 5, further comprising replicating one or more client communication protocols such that said third electronic device corresponds to another client device.

7. The method of claim 1, further comprising repeating said received said power and said data for said third electronic device.

8. The method of claim 1, wherein a connection interface of said third electronic device switches from a first interface to a second interface when a third communication channel is deployed between said third electronic device and a fourth electronic device.

9. The method of claim 8, wherein said third communication channel is an on-the-go (OTG) universal serial bus (USB) cable.

10. The method of claim 1, wherein said first communication channel comprises one of: a Universal Serial Bus (USB) cable, an Ethernet cable, and/or a cable with lightning connector.

11. The method of claim 1, wherein said wireless second communication channel is one of: a wireless fidelity (Wi-Fi) network, a Bluetooth network, a radio frequency (RF) network, and/or a near field communication (NFC) network.

12. The method of claim 1, wherein said transmission of said power via said wireless second communication channel is based on one or more wireless standards that include Qi™.

13. The method of claim 1, wherein said first electronic device is one of: an adaptor, a charger, a cradle and/or a connector.

14. The method of claim 1, wherein said second electronic device is one of: a personal computer (PC), a laptop, a smartphone, a tablet, a phablet and/or a personal digital assistant (PDA).

15. The method of claim 1, wherein said third electronic device is one of: a laptop, a smartphone, a tablet, a phablet and/or a personal digital assistant (PDA).

16. A system for wireless power and data transmission, said system comprising:
one or more processors in a first electronic device, said one or more processors being operable to:
receive power and data from a second electronic device via a first communication channel; and
transmit said received said power and said data to a third electronic device via a wireless second communication channel.

17. The system of claim 16, wherein said one or more processors are operable to charge a first battery apparatus based on said received power, wherein said power is received from a second battery apparatus installed within said second electronic device.

18. The system of claim 16, wherein said one or more processors are operable to perform authentication of said third electronic device prior to said transmission of said received said power and said data via said wireless second communication channel.

19. The system of claim 16, wherein said second electronic device corresponds to a host device and said first electronic device corresponds to a client device.

20. The system of claim 16, wherein said one or more processors are operable to replicate one or more client communication protocols such that said third electronic device corresponds to another client device.

21. The system of claim 16, wherein said one or more processors are operable to repeat said power and said data for said third electronic device.

22. The system of claim 16, wherein said third electronic device switches from a client interface to a host interface when a third communication channel is deployed between said third electronic device and a fourth electronic device.

23. A non-transitory computer readable storage medium having stored thereon, a computer program having at least one code section for wireless power and data transmission, the at least one code section being executable by a computer for causing the computer to perform steps comprising:
receiving power and data from a second electronic device via a first communication channel; and
transmitting said received said power and said data to a third electronic device via a wireless second communication channel.
